(19) United States
(12) Patent Application Publication
(10) Pub. No.: US 2025/0166885 A1
(43) Pub. Date: May 22, 2025

(54) NOVEL DESIGN AND PROCESS OF SCALABLE HIGH IMPEDANCE COMPONENTS

(71) Applicants: Applied Materials, Inc., Santa Clara, CA (US); The Florida International University Board of Trustees, Miami, FL (US)

(72) Inventors: Ghaleb Saleh Ghaleb Al-Duhni, Miami, FL (US); Mudit Sunilkumar Khasgiwala, Milpitas, CA (US); Markondeyaraj Pulugurtha, Miami, FL (US); Mohammad Mohtasim Hamid Pial, Miami, FL (US); Subramani Kengeri, Saratoga, CA (US); Kunal Ghosh, Bengaluru (IN); Meghna Maheshkumar Patel, Navsari (IN); Sachin Jayant Patil, Bengaluru (IN); Arvin Khosravi, Los Gatos, CA (US)

(73) Assignees: Applied Materials, Inc., Santa Clara, CA (US); The Florida International University Board of Trustees, Miami, FL (US)

(21) Appl. No.: 18/512,409

(22) Filed: Nov. 17, 2023

(51) Int. Cl. H01F 27/36; H01F 27/24; H01F 41/02

(52) U.S. Cl. CPC H01F 27/366; H01F 27/24; H01F 41/0206

(57) ABSTRACT

A scalable high-impedance component (SHIC) may include a flexible polyimide core may include one or more vias. The SHIC may include a magnetic film formed on one or more sides of the flexible polyimide core. The SHIC may include a polymer layer formed on the magnetic film, the polymer layer isolating the magnetic film and the flexible polyimide core. The SHIC may include a metal layer formed on the polymer layer and within the vias, such that the metal layer forms windings that extend through the one or more vias. The SHIC may include a magnetic paste disposed on the metal layer such that the SHIC shields a desired frequency of electromagnetic interference.

### TECHNICAL FIELD

The present technology relates to semiconductor systems, processes, and equipment. More specifically, the present technology relates to creation of noise-blocking inductors devices in a power distribution path.

### BACKGROUND

The coupling of noise between power management integrated circuits (PMIC) and radio frequency (RF) components poses significant challenges in the design and manufacturing of electronic devices. Existing solutions for radiation coupling components such as power lines to antennas and RF components may be difficult to implement upfront due to unknown design constraints in early product design stages. Noise suppression filters, such as electromagnetic interference (EMI) filters, choke inductors, or ferrite beads, may be used in high-speed digital systems to mitigate electromagnetic interference (EMI) issues caused by PMIC noise. However, the unpredictable nature of EMI from PMIC noise may require introducing noise suppression filters at the source. With increasing current-surges in high-performance computing, more stronger sources of noise generate noise that propagates throughout the package and interfere with other components. The noise also radiates out as electric, magnetic or electromagnetic fields. To prevent this, noise-blocking components need to be added along the power lines. This invention provides a new way of creating such components.

### BRIEF SUMMARY

A scalable high-impedance component (SHIC) may include a flexible polyimide core may include one or more vias. The SHIC may include a magnetic film formed on one or more sides of the flexible polyimide core. The SHIC may include a polymer layer formed on the magnetic film, the polymer layer isolating the magnetic film and the flexible polyimide core. The SHIC may include a metal layer formed on the polymer layer and within the vias, such that the metal layer forms windings that extend through the one or more vias. The SHIC may include a magnetic paste disposed on the metal layer such that the SHIC shields a desired frequency of electromagnetic interference.

In some embodiments, the magnetic paste may include metallic flakes, a size of the metallic flakes corresponding to the desired frequency of electromagnetic interference. An alternating current impedance of the SHIC may be above 1000 ohms. In some embodiments, the magnetic paste may include flakes of differing sizes. The flakes may include at least of nickel, iron, and cobalt. The magnetic film may include at least one of nickel, iron, cobalt, zirconia, and tantalum. The magnetic film may also be formed on a sidewall of the one or more vias.

A SHIC may include a flexible core. The SHIC may include a magnetic film formed on one or more sides of the flexible core. The SHIC may include a polymer layer formed on the magnetic film. The SHIC may include a metal layer formed on the polymer layer. The SHIC may include a magnetic paste may include metallic flakes, disposed on one or more sides of the SHIC.

In some embodiments, the magnetic paste may be applied to a thickness of about 100 micrometers. The magnetic paste may be selected to provide an alternating current impedance associated with a frequency range of about 200 mhz to about 1000 mhz. The flexible core may include polyimide. The metallic flakes may be between about 10 nanometers to about 10 micrometers. The alternating current impedance may be above 100 ohms at 100-1000 mhz. The alternating current impedance may be above 100 ohms and a total thickness of the SHIC may be less than 0.2 mm.

A method of forming a SHIC may include forming a magnetic film on a carrier core. The method may include forming a polymer layer on the magnetic film. The method may include forming a metal layer on at least some of the polymer layer. The method may include applying a magnetic paste to at least one side of the SHIC.

In some embodiments, the metal layer may include at least one of copper, silver, and nickel. The magnetic film may be deposited via sputtering. The magnetic film may include a cobalt alloy deposited using physical vapor deposition. The vias may include a diameter of about 25 micrometers. The metal paste is applied to the one or more sides of the SHIC to a thickness of about 100 micrometers.

### BRIEF DESCRIPTION OF THE DRAWINGS

FIG. 1 illustrates a flowchart of a method for forming a ferrite bead, according to certain embodiments.

FIGS. 2A-2G illustrates a process flow of a method for forming a ferrite bead, according to certain embodiments.

FIG. 3 illustrates a cross sectional view of a ferrite bead with an airgap, according to certain embodiments.

FIG. 4A illustrates a toroidal inductor with four windings, according to certain embodiments.

FIG. 4B illustrates a toroidal inductor with six windings, according to certain embodiments.

FIG. 4C illustrates a toroidal inductor with four angled windings, according to certain embodiments.

FIG. 4D illustrates a toroidal inductor with four windings, according to certain embodiments.

FIG. 4E illustrates a toroidal inductor with four angled windings, according to certain embodiments.

FIG. 5 illustrates a ferrite bead including a magnetic paste, according to certain embodiments.

FIG. 6 illustrates an exemplary computer system, in which various embodiments may be implemented.

### DETAILED DESCRIPTION OF THE INVENTION

Voltage regulators with integrated magnetics may be an important component of current and future electronic devices such as high-performance computing systems, mobile processors in smartphones, or any mixed-signal systems. Such systems may rely on advanced system packaging technologies such as heterogeneous chiplet integration on interposers and substrates or more traditional multichip packaging with surface-assembled on embedded components. High-speed switching circuits may induce noise into the system, some of which is radiated out as near-field electromagnetic fields or far-field electromagnetic fields. Some part of the noise may propagate through the system in conduction mode along the power transmission lines. This noise may be filtered or blocked through several approaches such as EMI filter inductors (e.g., ferrite beads or a ferrite wrap around a current-carrying coil), electromagnetic bandgap (EBG) structures, or by utilizing metamaterial structures such as frequency-selective surfaces.

EMI filter inductors may have several attributes including high inductance to form high impedance, low direct current (DC) resistance such that the DC power is not lost, high alternating current (AC) losses to create additional impedance from the loss tangent, and an overall design that may be flat and compact. EMI filter inductors may also not cause radiated fields, be able to handle high current, and may dissipate heat generated during operation. Such inductors may be fabricated with a single magnetic material. However, single magnetic material fabrication limits the scalability of the impedance of the inductors and may not benefit from the additional benefits of other materials. When multiple materials are utilized, the impedances from the intrinsic properties may be effectively combined. For example, thin-film magnetic cores sustain high permeability and may lead to high inductance or impedance. When combined with thick magnetic particles of various shapes, additional impedance may be affected by utilizing its ferromagnetic resonance or other loss contributions from eddy currents that lead to higher impedance. Systems and methods described herein may utilize a combination of magnetic films to create a scalable impedance device in small form-factor.

The specific combination of thin magnetic films as inner layers and thick magnetic films as outer layers is specifically advantageous as the inner layers gain impedance from the high permeability at high frequencies. The inner layers may be wrapped with the winding to provide high inductance. On the other hand, outer layers may boost the impedance further with a FMR and other loss contribution. The particle size and its intrinsic field anisotropy from its composition and structure determines its ferromagnetic resonance. Peak impedance may be reached at the FMR. By choosing the particle size and chemistry, the peak AC impedance may be achieved in a narrow or broadband. The outer layers also provide shielding. This shielding may prevent radiation noise leaking to the adjacent components to cause their malfunction, or other electromagnetic compatibility issues.

One way to increase the inductance of an integrated inductor is to increase the number of windings (generally copper) included in the inductor. As the number of windings increases, however, the resistance also increases. Furthermore, the amount of current ripple or drift may also increase. Minimizing the number of copper windings in an integrated inductor may address some of these issues. The maximum current that an inductor can handle is directly related to the reluctance of the magnetic core, while inductance is inversely related to the reluctance. Reluctance is directly proportional to the length of the core and inversely related to the cross-sectional area. Toroidal inductors with an airgap may provide lowest reluctance and high inductance. A relatively thick magnetic core may further increase the inductance without increasing the footprint or coil length of the inductors. To form such inductors, nanomagnetic films (sometimes “magnetic films”) may be deposited on multiple sides of a flexible core to form an integrated scalable high-impedance component (SHIC). The flexible core may include cavities or vias, that pass through the flexible core. The SHIC isolation layer may then be formed and the SHIC may be planarized. Then, a metal layer may be formed on the SHIC (e.g., via plating). This process may offer several benefits. For example, the process (or “SHIC approach”) may eliminate several integration issues with patterning a toroid inductor with an airgap as the vias are drilled before the metal layer is formed. The process may also enhance throughput because of the multi-sided sputtering. Inductors formed from the above process may offer performance benefits such as higher current-handling and efficiency due in part to the multi-sided deposition.

An inductor formed via the SHIC approach may be used as a ferrite bead. It should be understood that any references herein to a ferrite bead may include any type of integrated scalable high-impedance component. The ferrite bead may passively filter EMI over a broad frequency range. In other words, the ferrite bead may shield other components within an electronic device from EMI (e.g., noise generated by a PMIC). While an inductor formed via the SHIC approach may shield some EMI, the inductor's effectiveness as a ferrite bead may be substantially increased by applying a magnetic paste to one or more sides of the ferrite bead. The magnetic paste may contain particles that increase the alternating current (AC) impedance of the ferrite bead within a certain frequency range. Thus, the ferrite bead may be tuned, at least in part, by choosing a magnetic paste with particular components to provide stronger shielding for a desired frequency of EMI.

Ferrite beads may need high AC impedance while keeping the DC resistance low. The AC impedance may come from the inductance and core losses. The DC resistance may be lowered by minimizing the copper length. By utilizing a combination of materials to enhance both inductance and loss, high AC impedance with low DC resistance may be achieved. The scalable high impedance component (SHIC) may achieves this with thin cores, high-permeability films on the core, and high-magnetic-loss overlaps above the thin core. Impedances of 100s of Ohms may be achieved with very small thickness and low DC resistance of few 10 s of milliohms.

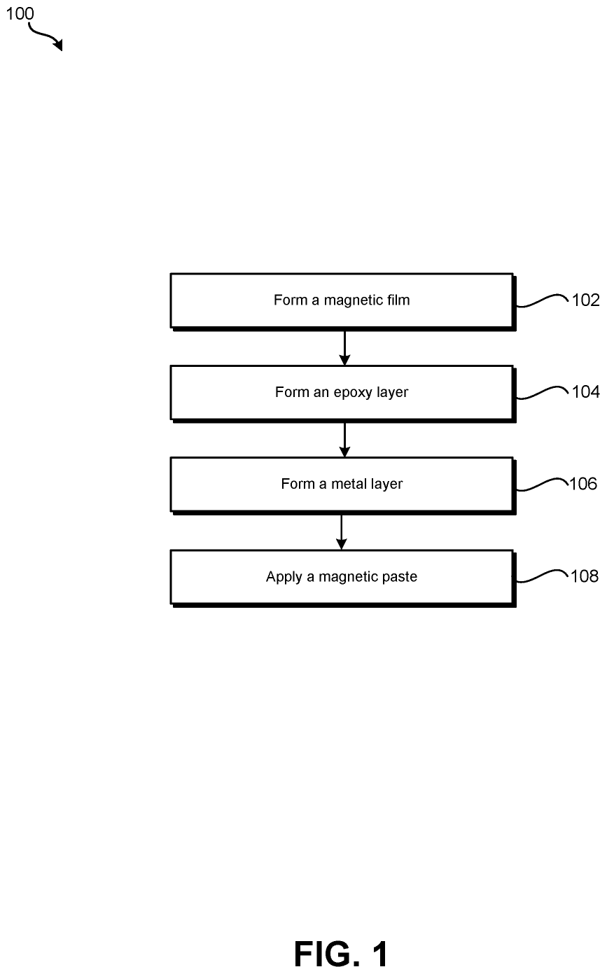

FIG. 1 illustrates a flowchart of a method 100 for forming a SHIC, according to certain embodiments. Steps of the method 100 may be performed in a different order than is shown in FIG. 1 and/or combined with other steps of the method 100. In some embodiments, some of the steps of the method 100 may be skipped altogether. While some embodiments refer to a ferrite bead, it should be understood that the methods and system described herein may be applied to any SHIC.

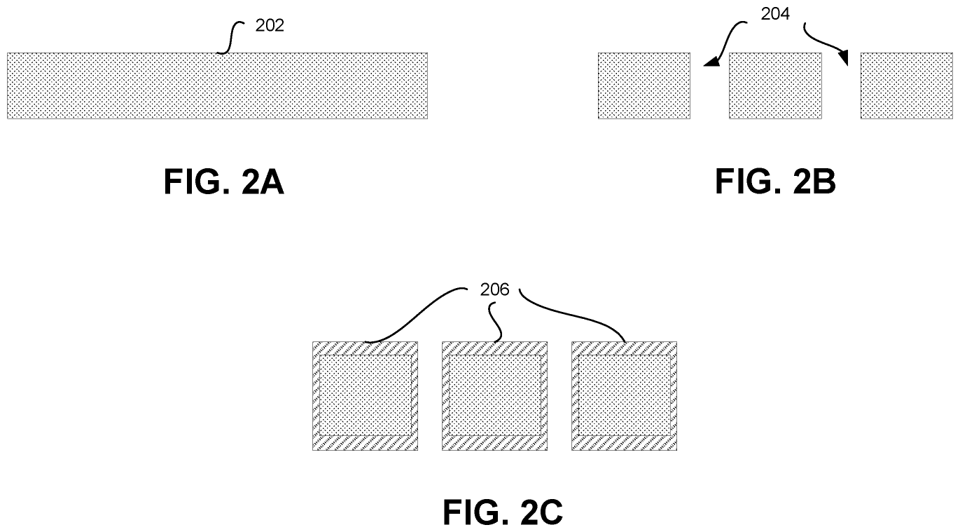

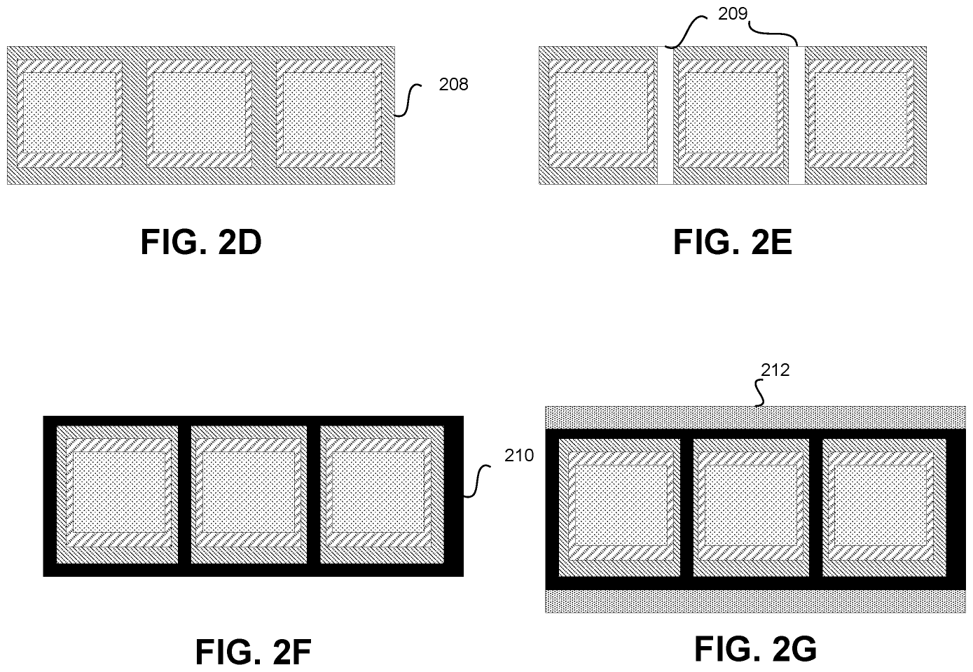

At step 102, the method 100 may include forming a magnetic film 206 on a flexible core 202. In FIG. 2A, a flexible core 202 may be provided. The flexible core 202 may be a carrier core. The flexible core 202 may comprise polyimide, Molypermalloy powder cores, High Flux, kool Mu®/Sendust, or other suitable core materials. The flexible core 202 may have a thickness of about 15 μm, about 20 μm, about 30 μm, about 35 μm, or about 40 μm. The flexible core 202 may be an “off-the-shelf” product or may be manufactured as part of the method 100. During a manufacturing process, the flexible core 202 may be supported by a framework, grid frame, or other suitable device. The framework may provide a template for features to be formed on the flexible core 202, such as patterning for a deposition or etching process, guides holes for drilling or ablation, and/or any other such process.

As shown in FIG. 2B, first vias 204 may be formed in the flexible core 202. The first vias 204 may be formed using a laser, mechanical drill, or formed via an etching and/or ablation process. The first vias 204 may include a diameter of about 10 μm, about 15 μm, about 20 μm, about 25 μm, about 30 μm, about 40 μm, about 50 μm, about 60 μm, and/or about 70 μm. In some embodiments, all of the first vias 204 include the same diameter. In other embodiments, the first vias 204 may include different diameters. In either case, the first vias 204 may extend through a top and bottom side of the flexible core 202.

As shown in FIG. 2C, the magnetic film 206 may be formed on multiple sides of the flexible film 202. The magnetic film 206 may be formed on sidewalls of the first vias 204. The magnetic film may be deposited to a thickness of about 10 μm, about 15 μm, about 20 μm, about 25 μm, or about 30 μm. The magnetic film 206 may include nickel, iron, cobalt, zirconia, tantalum, and/or any other suitable material. The magnetic film 206 may include a single material or may include combinations and alloys of any or all of the aforementioned materials. In some embodiments, the magnetic film 206 may be formed by sputtering one or more materials on the flexible core 202. In other embodiments, the magnetic film 206 may be formed by physical vapor deposition (PVD), atomic layer deposition (ALD), or any other type of deposition. In some embodiments, an oxide layer may be formed on the magnetic film 206. The oxide layer may serve as a dielectric and aid in isolating the magnetic film 206 from other layers of the inductor.

At step 104, the method 100 may include forming a polymer layer 208 on the magnetic film 206, as shown in FIG. 2D. The polymer layer 208 may be formed to a thickness of about 5 μm, about 10 μm, about 15 μm, or about 20 μm. The polymer layer 208 may be formed on the top side and bottom side of the flexible core 202. The polymer layer 208 may also be formed in the first vias 204. The polymer layer 208 may completely or partially fill some or all of the first vias 204. Thus, the polymer layer 208 may isolate the flexible core 202 and the magnetic film 206. The flexible core 202 and the magnetic film 206 may therefore be thought of as a magnetic core of the inductor.

The polymer layer 208 may include one or more polymers or other suitable materials. The polymer layer 208 may include a dielectric material such as polypropylene, cyclic transparent optical fluoropolymer (CYTOP), polypropylene-co-1-butene, or other suitable polymers and/or materials. The polymer layer 208 may planarize the magnetic film 206. For example, forming the magnetic film 206 may create imperfections or an uneven surface. The polymer layer 208 may be formed such that the imperfections are filled in and/or such that a surface of the polymer layer 208 is even.

In some embodiments, the method may include forming second vias 209 through the polymer layer 208, as shown in FIG. 2E. The second vias 209 may correspond to the first vias 204, passing through the same pathway as the first vias 204. Thus, each of the second vias 209 be a cavity surrounded by a dielectric layer (e.g., the polymer layer 208) and the magnetic film 206. The second vias 209 may be formed using a laser, mechanical drill, or formed via an etching and/or ablation process. The second vias 209 may include a diameter of about 10 μm, about 15 μm, about 20 μm, about 25 μm, about 30 μm, about 40 μm, and/or about 50 μm.

At step 106, the method 100 may include forming a metal layer 210 on at least a portion of the polymer layer 208, as shown in FIG. 2F. The metal layer 210 may include copper, silver, nickel, and/or any other suitable metal. The metal layer 210 may be formed via PVD, ALD, sputtering, or other suitable deposition processes. The metal layer 210 may additionally or alternatively be formed via an electroplating process. The metal layer 210 may be formed to a thickness of about 5 μm, about 10 μm, about 15 μm, about 20 μm, or about 30 μm.

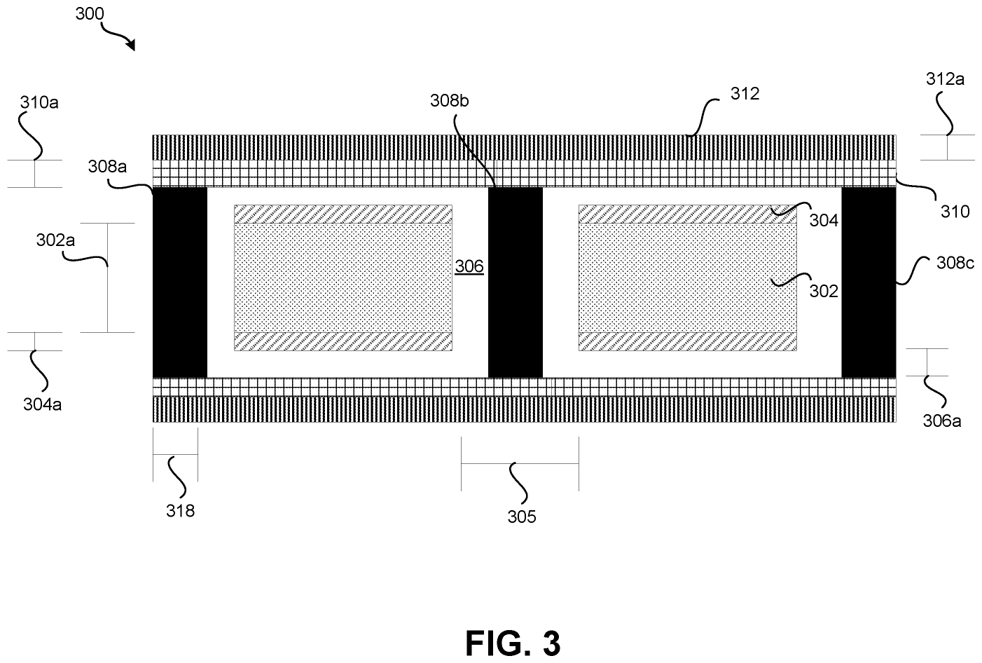

The metal layer 210 may be formed on the top side and the bottom side of the inductor and within the second vias 209 such that the second vias 209 mare completely filled. The metal layer 210 may therefore form windings (e.g., a copper winding) surrounding the magnetic core (e.g., the flexible core 202 and the magnetic film 206). The windings and the magnetic core may form components of the inductor (such as the ferrite bead 300 in FIG. 3). The polymer layer 208 may isolate the magnetic core from the windings, improving the performance of the inductor. In some embodiments, the windings may form a toroidal shape. As discussed above, a toroidal shape may provide for greater inductance and/or other performance metrics of an inductor.

At step 108, the method 100 may include applying a magnetic paste 212 to the inductor, as shown in FIG. 2G. The magnetic paste 212 may comprise flakes of a material suspended in a paste or slurry. The magnetic paste 212 may include graphene, silver, and/or other suitable materials. The flakes may include nickel, iron, cobalt, iron, and/or any alloys thereof. The flakes may range in size from about 10 nm to about 20 μm, inclusive. The magnetic paste 212 may include homogenous flakes of the same size or may contain a mixture of any flake size and material.

The magnetic paste 212 may be chosen based at least in part on desired frequency of EMI to be shielded. For example, EMI of a particular frequency may be incident on an electronic device. An inductor may then be selected for its inductance at the particular frequency. The magnetic paste 212 may then be selected to increase an AC impedance (i.e., the effectiveness at shielding the particular frequency such as about 200 MHz to 1000 MHz) of the inductor. The magnetic paste 212 may then be applied to the inductor, creating a ferrite bead.

The magnetic paste 212 may be applied to the inductor to a thickness of about 80 μm, about 90 μm, about 100 μm, about 120 μm, or about 150 μm. The magnetic paste 212 may be applied to both sides of the inductor, as is shown in FIG. 2G, or may be applied to only one side. In some embodiments, the magnetic paste 212 may be applied at a different thickness in different regions. For example, the magnetic paste 212 may be applied at 100 μm on a top side of the inductor and may be applied to 50 μm on a bottom side of the inductor. Furthermore, different magnetic pastes may be applied to different sides of the inductor (e.g., magnetic pastes with different sized flakes and/or different materials).

Additionally or alternatively, one or more multi-layered shielding structures may be applied to the magnetic paste 212 and/or the inductor. The multi-layered shielding structures may include one or more layers of metals such as nickel, iron, copper, cobalt, tantalum, aluminum, and other such metals. The multi-layered shielding structures may include alternating layers of metals or a single layer of a single metal. The layers of the multi-layered shielding structure may be chosen based at least in part on the desired frequency of EMI to be shielded. The multi-layered shielding structure may be applied to the inductor on the magnetic paste 212 or may be placed on the inductor in lieu of the magnetic paste 212.

FIG. 3 illustrates a cross sectional view of a ferrite bead 300 with an airgap 305, according to certain embodiments. The ferrite bead 300 may be formed by a process, such as is described in relation to the method 100 in FIG. 1 and in FIGS. 2A-2F. The ferrite bead 300 may therefore include similar properties and components described therein. The ferrite bead 300 may include a flexible core 302, a magnetic film 304, an isolation layer 306, metal pathways 308a-c, a metal layer 310, and a magnetic paste 212. The flexible core 302 and the magnetic film 304 may form a magnetic core of the ferrite bead 300. The flexible core 302 may include polyimide and/or any other suitable material for forming a flexible core. The flexible core 302 may include a core thickness 302a. The core thickness 302a may be about 30 μm. In other embodiments, the core thickness 302a may be about 15 μm, about 20 μm, about 35 μm, or about 40 μm.

The magnetic film 304 may include nickel, iron, cobalt, zirconia, tantalum, and/or any other suitable material. The magnetic film 304 may include a single material or may include combinations and alloys (e.g., a cobalt alloy) of any or all of the aforementioned materials. The magnetic film 304 may include a film thickness 304a. The film thickness 304a may be about 15 μm. In other embodiments, the film thickness 304a may be about 10 μm, about 20 μm, about 25 μm, or about 30 μm.

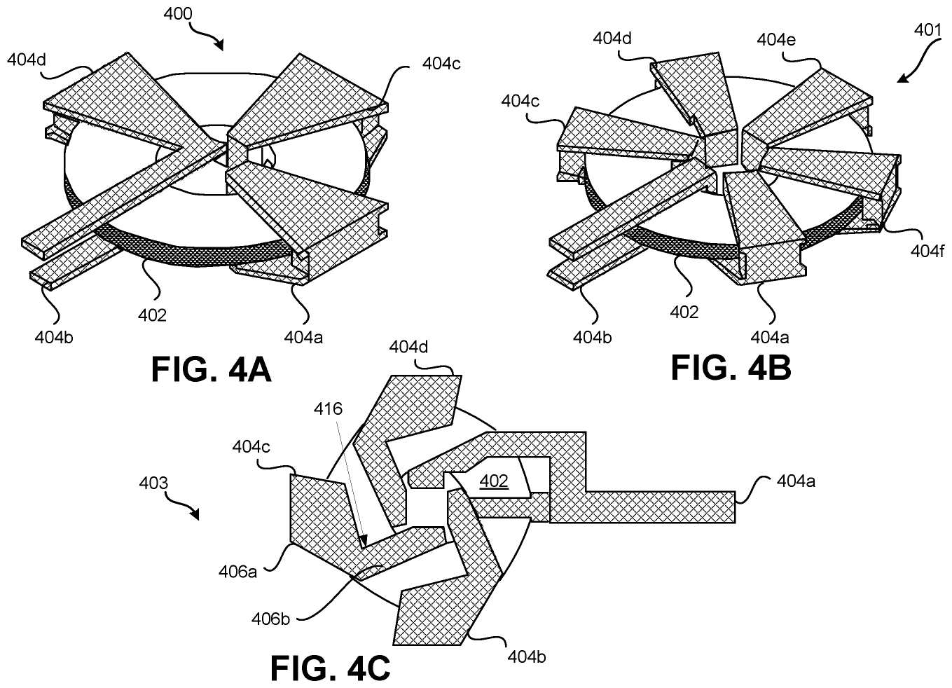

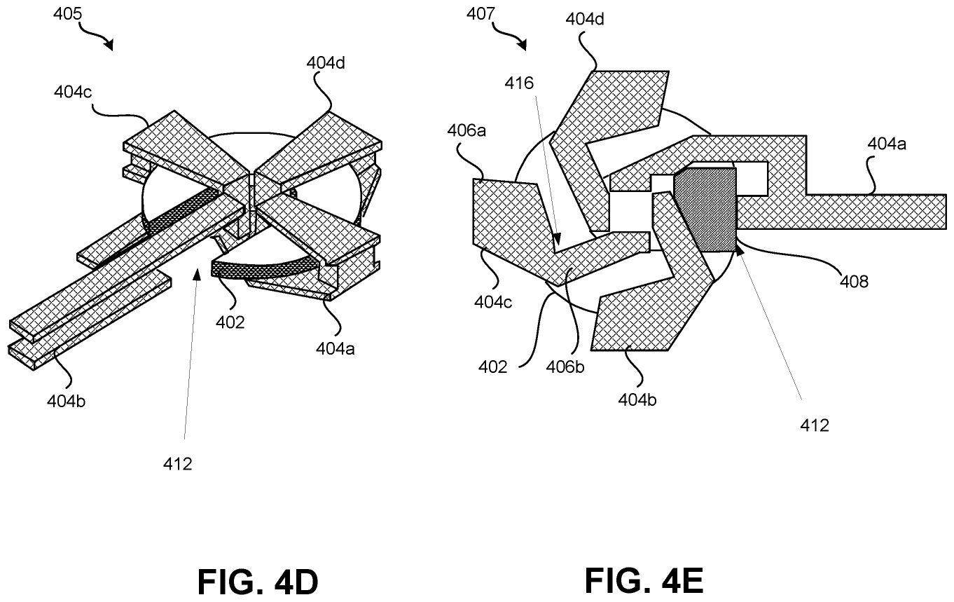

The magnetic core of the ferrite bead 300 (i.e., the flexible core 302 and the magnetic film 304) may be substantially round. The magnetic core may also include an airgap 305. The airgap 305 may be formed in the flexible core 302 prior to forming the magnetic film 304. The airgap 305 may be formed via etching, laser cutting ablation, or any other suitable method. In relation to FIG. 3, the magnetic core may extend into the page, forming a partial disk. The two sides of the magnetic core shown in FIG. 3 may therefore be a unitary piece, with the airgap 305 in one side of the partial disk. A top down view of a similar magnetic core may be seen in FIG. 4D. The airgap 305 may have a width of about 120 μm. In other embodiments, the airgap 305 may include a width of about 80 μm, about 90 μm, about 100 μm, about 150 μm, or about 200 μm.

The isolation layer 306 may be similar to the polymer layer 208 in FIGS. 2C-2F. The isolation layer 306 may accordingly include a dielectric material, as described above. The isolation layer 306 may also include an oxide formed on the magnetic film 304. The isolation layer 306 may fill the airgap 305. In some embodiments, the airgap 305 may not include the isolation layer 306. The isolation layer 306 may include a dielectric thickness 306a. The dielectric thickness 306a may be about 10 μm. In other embodiments, the dielectric thickness 306a may be about 5 μm, about 15 μm, or about 20 μm. The isolation layer 306 may be uniform, having the same dielectric thickness 306a in all regions. In other embodiments, the isolation layer 306 may include different dielectric thicknesses 306a in different regions (e.g., the dielectric thickness within airgap 305 may be different than the dielectric thickness on the bottom side of the ferrite bead 300).

The metal pathways 308a-c may include copper and may extend through the top side and the bottom side of the magnetic core and the isolation layer 306. The metal pathways 308a-c may include a via width 318. The via width 318 may be about 36 μm. In other embodiments, the via width 318 may be about 20 μm, about 30 μm, about 40 μm, or about 50 μm. The metal pathways 308a-c may be formed as part of and/or be connected to the metal layer 310. The metal layer 310 may also include copper. The metal layer 310 may include a metal thickness 310a of about 15 μm. In other embodiments, the metal thickness 310a may be about 5 μm, about 10 μm, about 20 μm, or about 30 μm.

The metal pathways 308a-c and the metal layer 310 may form copper windings about the magnetic core. The copper windings may pass through vias or cavities through the magnetic core and the isolation layer 306. As described above, the magnetic core may be a disc (or partial disk). The copper windings may therefore form a toroid about the magnetic core. In other words, the ferrite bead 300 may include a toroidal inductor and the airgap 305. Thus, the ferrite bead 300 may have better inductance and lower current ripple and DC resistance as compared to other inductors.

The magnetic paste 312 may be similar to the magnetic paste 212 in FIG. 2G. As such, the magnetic paste 312 may include metallic flakes suspended in a material. The magnetic paste 312 may be chosen based at least in part on a desired frequency of EMI to be shielded. The magnetic paste 312 may be applied to the toroidal inductor to a paste thickness 312a. The paste thickness 312a may be about 100 μm. In other embodiments, the paste thickness 312a may be about 80 μm, about 90 μm, about 120 μm, or about 150 μm. In some embodiments, the ferrite bead 300 may include a multi-layered shielding structure, as described in FIG. 2G. The multi-layered shielding structure may be included in the ferrite bead 300 in addition to or instead of the magnetic paste 312.

The ferrite bead 300 may include an AC impedance above 100 Ohms at a frequency of about 100 MHz to about 1000 MHz or greater. The ferrite bead 300 may include an AC impedance greater than about 100 Ohms while having a total thickness of less than 0.2 mm.

FIG. 4A illustrates a toroidal inductor 400 with four windings 404a-d, according to certain embodiments. The toroidal inductor 400 may be similar to the ferrite bead 300 in FIG. 3 and include similar features, measurements, and capabilities. The toroidal inductor 400 may be formed by a process such as the method 100 in FIG. 1 and FIGS. 2A-2F. The toroidal inductor 400 may include a magnetic core 402 and the windings 404a-d. The magnetic core 402 may be disc-shaped and include a pathway in the center. The magnetic core 402 may include a flexible core and a magnetic film, such as the flexible core 302 and the magnetic film 304 in FIG. 3.

The windings 404a-d may be separated at regular radial intervals about the center of the magnetic core 402. For example, the windings 404a-d may be disposed every 90° about the magnetic core 402. One or more of the windings 404a-d (e.g., the winding 404b) may be connected to a power source (not pictured). The power source may provide an alternating current or a DC to the windings 404a-d such that the toroidal inductor 400 operates according to design (e.g., as a high switching regulator).

FIG. 4B illustrates a toroidal inductor 401 with six windings 404a-f, according to certain embodiments. The toroidal inductor 401 may be similar to the ferrite bead 300 in FIG. 3 and include similar features, measurements, and capabilities. The toroidal inductor 401 may be formed by a process such as the method 100 in FIG. 1 and FIGS. 2A-2F. The toroidal inductor 401 may include a magnetic core 402 and the windings 404a-f. The magnetic core 402 may be disc-shaped and include a pathway in the center. The magnetic core 402 may include a flexible core and a magnetic film, such as the flexible core 302 and the magnetic film 304 in FIG. 3.

The windings 404a-f may be separated at regular radial intervals about the center of the magnetic core 402. For example, the windings 404a-f may be disposed every 60° about the magnetic core 402. One or more of the windings 404a-f (e.g., the winding 404b) may be connected to a power source (not pictured). The power source may provide an alternating current or a DC to the windings 404a-f such that the toroidal inductor 400 operates according to design (e.g., as a high switching regulator).

FIG. 4C illustrates a toroidal inductor 403 with four angled windings 404a-d, according to certain embodiments. The toroidal inductor 403 may be similar to the ferrite bead 300 in FIG. 3 and include similar features, measurements, and capabilities. The toroidal inductor 403 may be formed by a process such as the method 100 in FIG. 1 and FIGS. 2A-2F. The toroidal inductor 403 may include a magnetic core 402 and the angled windings 404a-d. The magnetic core 402 may be disc-shaped and include a pathway in the center. The magnetic core 402 may include a flexible core and a magnetic film, such as the flexible core 302 and the magnetic film 304 in FIG. 3.

The angled windings 404a-d may be separated at regular radial intervals about the center of the magnetic core 402. For example, the angled windings 404a-d may be disposed every 60° about the magnetic core 402. One or more of the angled windings 404a-d (e.g., the angled winding 404a) may be connected to a power source (not pictured). The power source may provide an alternating current or a DC to the angled windings 404a-d such that the toroidal inductor 400 operates according to design (e.g., as a high switching regulator).

The angled windings 404a-d may include a first arm 406a and a second arm 406b. Although only the angled winding 404c is labelled with the first arm 406a and the second arm 406b, it should be understood that all of the angled windings 404a-d may include a first arm and a second arm. The first arm 406a and second arm 406b may meet to form an angle 416. The angle 416 may be within a range of about 60° to about 120°, inclusive. The first arm 406a and the second arm 406b may increase a surface area of the angled winding 404c and/or the overall length of the angled winding 404c. Thus, the toroidal inductor 403 may exhibit different operating characteristics than other inductors (e.g., operating frequency, inductance, reluctance, etc.).

FIG. 4D illustrates a toroidal inductor 405 with four windings 404a-d, according to certain embodiments. The toroidal inductor 405 may be similar to the ferrite bead 300 in FIG. 3 and include similar features, measurements, and capabilities. The toroidal inductor 405 may be formed by a process such as the method 100 in FIG. 1 and FIGS. 2A-2F. The toroidal inductor 405 may include a magnetic core 402 and the windings 404a-d. The magnetic core 402 may be disc-shaped and include a pathway in the center. The magnetic core 402 may include a flexible core and a magnetic film, such as the flexible core 302 and the magnetic film 304 in FIG. 3.

The magnetic core 402 may also include an airgap 412. The airgap 412 may be similar to the airgap 305 in FIG. 3. Thus, the airgap 412 may be formed as part of a production process of the flexible core and/or formed through an etching process, cutting process (e.g., laser cutting), ablation, or any other suitable method.

The windings 404a-d may be separated at regular radial intervals about the center of the magnetic core 402. For example, the windings 404a-d may be disposed every 90° about the magnetic core 402. One or more of the windings 404a-d (e.g., the winding 404b) may be connected to a power source (not pictured). The power source may provide an alternating current or a DC to the windings 404a-d such that the toroidal inductor 405 operates according to design (e.g., as a high switching regulator).

FIG. 4E illustrates a toroidal inductor 407 with four angled windings 404a-d, according to certain embodiments. The toroidal inductor 407 may be similar to the ferrite bead 300 in FIG. 3 and include similar features, measurements, and capabilities. The toroidal inductor 407 may be formed by a process such as the method 100 in FIG. 1 and FIGS. 2A-2F. The toroidal inductor 407 may include a magnetic core 402 and the angled windings 404a-d. The magnetic core 402 may be disc-shaped and include a pathway in the center. The magnetic core 402 may include a flexible core and a magnetic film, such as the flexible core 302 and the magnetic film 304 in FIG. 3.

The magnetic core 402 may also include an airgap 412. The airgap 412 may be similar to the airgap 305 in FIG. 3. Thus, the airgap 412 may be formed as part of a production process of the flexible core and/or formed through an etching process, cutting process (e.g., laser cutting), ablation, or any other suitable method. As shown in FIG. 4E, the airgap 412 may include a magnetic paste 408. The magnetic paste 408 may allow the toroidal inductor 407 to be tuned to various applications (e.g., a ferrite bead, noise choke, a voltage regulator, etc.). The magnetic paste 408 may include iron, silver, graphene, cobalt, nickel, and/or any other suitable material.

The angled windings 404a-d may include a first arm 406a and a second arm 406b. Although only the angled winding 404c is labelled with the first arm 406a and the second arm 406b, it should be understood that all of the angled windings 404a-d may include a first arm and a second arm. The first arm 406a and second arm 406b may meet to form an angle 416. The angle 416 may be within a range of about 60° to about 120°, inclusive. The first arm 406a and the second arm 406b may increase a surface area of the angled winding 404c and/or the overall length of the angled winding 404c. Thus, the toroidal inductor 403 may exhibit different operating characteristics than other inductors (e.g., operating frequency, inductance, reluctance, etc.).

It should be understood that FIGS. 4A-E are merely provided as examples. Features of any of the toroidal inductors shown in any of FIGS. 4A-E may be combined with the features of any other toroidal inductor. One of ordinary skill in the art would recognize many different configurations and possibilities.

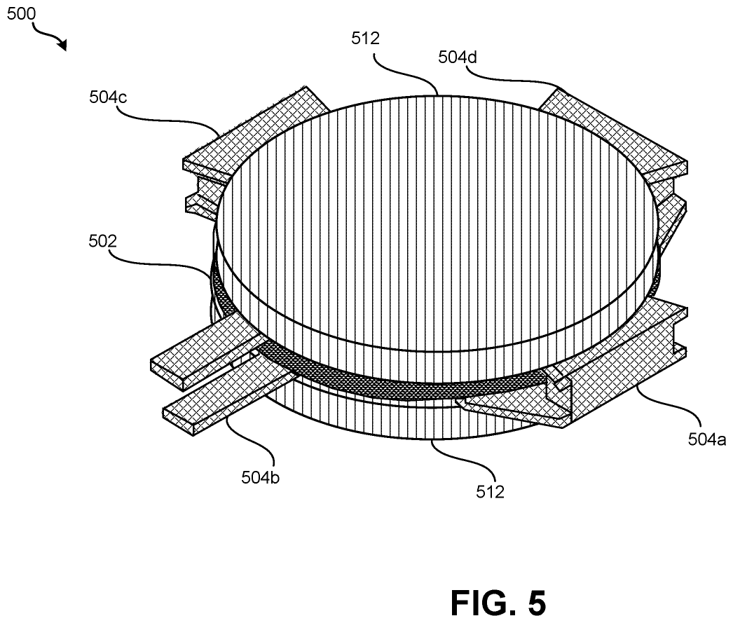

FIG. 5 illustrates a ferrite bead 500 including a magnetic paste 512, according to certain embodiments. The ferrite bead 500 may include a toroidal inductor, such as the toroidal inductor 400 in FIG. 4A. The ferrite bead 500 may therefore include a magnetic core 502, windings 504a-d, and the magnetic paste 512. The windings 504a-d may be separated at regular radial intervals about the center of the magnetic core 502. For example, the windings 504a-d may be disposed every 90° about the magnetic core 502. One or more of the windings 504a-d (e.g., the winding 504b) may be connected to a power source (not pictured).

The magnetic paste 512 may be applied to a top side and a bottom side of the ferrite bead 500, as shown in FIG. 5. The magnetic paste 512 may be applied to a thickness of about 100 μm. The magnetic paste 512 may be selected, at least in part based on a desired frequency of EMI to be shielded. A flake size (or particle size) may affect the AC impedance provided by the magnetic paste. For example, the frequency of EMI to be shielded may be within a range of about 1 MHz to about 10 MHz. Then, the magnetic paste 512 may include large microparticles (e.g., 10 μm). In another example, the frequency of EMI to be shielded may be within a range of about 100 MHz to about 500 MHz. Then, the magnetic paste 512 may include submicron particles (e.g., 400 nm). In yet another example, the frequency of EMI to be shielded may be within a range of about 500 MHz to about 1500 MHz. Then, the magnetic paste 512 may include nanoparticles (e.g., 10 nm). One of ordinary skill in the art would recognize many different possibilities and configurations. Although FIG. 5 is illustrated as including a toroidal inductor similar to the toroidal inductor 400, it should be understood that the ferrite bead 500 may include any inductor described herein, with any number of windings and/or including an airgap.

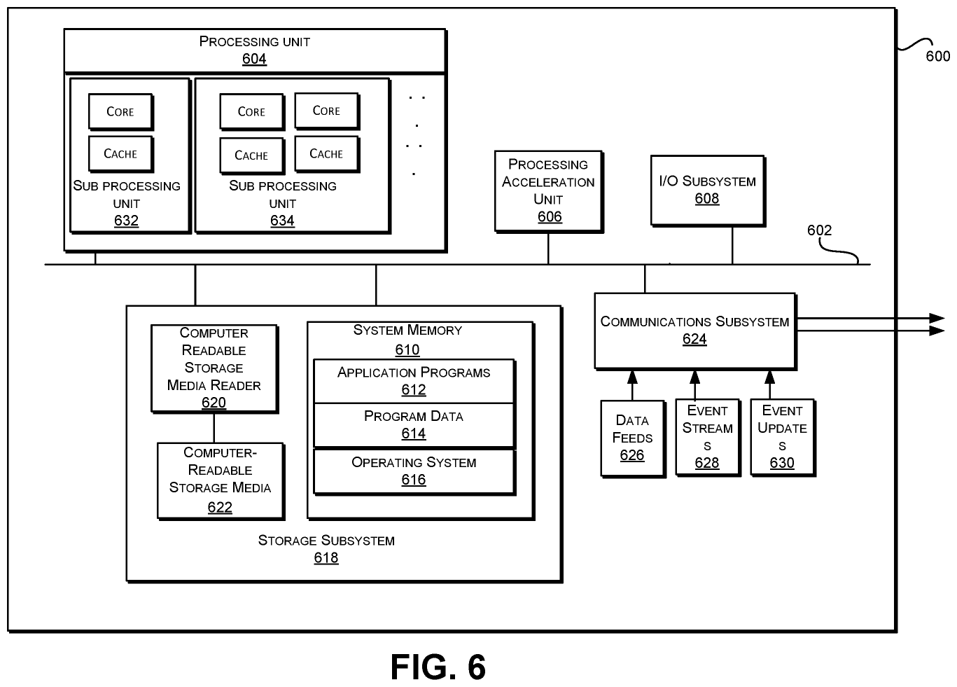

FIG. 6 illustrates an exemplary computer system 600, in which various embodiments may be implemented. The system 600 may be used to implement any of the computer systems described above. As shown in the figure, computer system 600 includes a processing unit 604 that communicates with a number of peripheral subsystems via a bus subsystem 602. These peripheral subsystems may include a processing acceleration unit 606, an I/O subsystem 608, a storage subsystem 618 and a communications subsystem 624. Storage subsystem 618 includes tangible computer-readable storage media 622 and a system memory 610.

Bus subsystem 602 provides a mechanism for letting the various components and subsystems of computer system 600 communicate with each other as intended. Although bus subsystem 602 is shown schematically as a single bus, alternative embodiments of the bus subsystem may utilize multiple buses. Bus subsystem 602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 604, which can be implemented as one or more integrated circuits (e.g., a conventional microprocessor or microcontroller), controls the operation of computer system 600. One or more processors may be included in processing unit 604. These processors may include single core or multicore processors. In certain embodiments, processing unit 604 may be implemented as one or more independent processing units 632 and/or 634 with single or multicore processors included in each processing unit. In other embodiments, processing unit 604 may also be implemented as a quad-core processing unit formed by integrating two dual-core processors into a single chip.

In various embodiments, processing unit 604 can execute a variety of programs in response to program code and can maintain multiple concurrently executing programs or processes. At any given time, some or all of the program code to be executed can be resident in processor(s) 604 and/or in storage subsystem 618. Through suitable programming, processor(s) 604 can provide various functionalities described above. Computer system 600 may additionally include a processing acceleration unit 606, which can include a digital signal processor (DSP), a special-purpose processor, and/or the like.

I/O subsystem 608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices that enables users to control and interact with an input device through a natural user interface using gestures and spoken commands. Additionally, user interface input devices may include voice recognition sensing devices that enable users to interact with voice recognition systems through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader, 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 600 may comprise a storage subsystem 618 that comprises software elements, shown as being currently located within a system memory 610. System memory 610 may store program instructions that are loadable and executable on processing unit 604, as well as data generated during the execution of these programs.

Depending on the configuration and type of computer system 600, system memory 610 may be volatile (such as random access memory (RAM)) and/or non-volatile (such as read-only memory (ROM), flash memory, etc.). The RAM typically contains data and/or program modules that are immediately accessible to and/or presently being operated and executed by processing unit 604. In some implementations, system memory 610 may include multiple different types of memory, such as static random access memory (SRAM) or dynamic random access memory (DRAM). In some implementations, a basic input/output system (BIOS), containing the basic routines that help to transfer information between elements within computer system 600, such as during start-up, may typically be stored in the ROM. By way of example, and not limitation, system memory 610 also illustrates application programs 612, which may include client applications, Web browsers, mid-tier applications, relational database management systems (RDBMS), etc., program data 614, and an operating system 616.

Storage subsystem 618 may also provide a tangible computer-readable storage medium for storing the basic programming and data constructs that provide the functionality of some embodiments. Software (programs, code modules, instructions) that when executed by a processor provide the functionality described above may be stored in storage subsystem 618. These software modules or instructions may be executed by processing unit 604. Storage subsystem 618 may also provide a repository for storing data used in accordance with some embodiments.

Storage subsystem 600 may also include a computer-readable storage media reader 620 that can further be connected to computer-readable storage media 622. Together and, optionally, in combination with system memory 610, computer-readable storage media 622 may comprehensively represent remote, local, fixed, and/or removable storage devices plus storage media for temporarily and/or more permanently containing, storing, transmitting, and retrieving computer-readable information.

Computer-readable storage media 622 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information, and which can be accessed by computing system 600.

By way of example, computer-readable storage media 622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD or other optical media. Computer-readable storage media 622 may include, but is not limited to, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to connect to one or more devices via the Internet. In some embodiments communications subsystem 624 can include radio frequency (RF) transceiver components for accessing wireless voice and/or data networks (e.g., using cellular telephone technology, advanced data network technology, such as 3G, 4G, 6G, or EDGE (enhanced data rates for global evolution), WiFi (IEEE 802.6 family standards, or other mobile communication technologies, or any combination thereof), global positioning system (GPS) receiver components, and/or other components. In some embodiments communications subsystem 624 can provide wired network connectivity (e.g., Ethernet) in addition to or instead of a wireless interface.

In some embodiments, communications subsystem 624 may also receive input communication in the form of structured and/or unstructured data feeds 626, event streams 628, event updates 630, and the like on behalf of one or more users who may use computer system 600.

By way of example, communications subsystem 624 may be configured to receive data feeds 626 in real-time from users of social networks and/or other communication services, web feeds such as Rich Site Summary (RSS) feeds, and/or real-time updates from one or more third party information sources.

Additionally, communications subsystem 624 may also be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 624 may also be configured to output the structured and/or unstructured data feeds 626, event streams 628, event updates 630, and the like to one or more databases that may be in communication with one or more streaming data source computers coupled to computer system 600.

Due to the ever-changing nature of computers and networks, the description of computer system 600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have beeen described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have beeen described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

What is claimed is:

1. A scalable high-impedance component (SHIC), comprising:
a flexible polyimide core comprising one or more vias;
a magnetic film formed on one or more sides of the flexible polyimide core;
a polymer layer formed on the magnetic film, the polymer layer isolating the magnetic film and the flexible polyimide core;
a metal layer formed on the polymer layer and within the vias, such that the metal layer forms windings that extend through the one or more vias; and
a magnetic paste disposed on the metal layer such that the SHIC shields a desired frequency of electromagnetic interference.

2. The scalable high-impedance component (SHIC) of claim 1, wherein the magnetic paste comprises flakes of a material, a size the flakes corresponding to the desired frequency of electromagnetic interference.

3. The SHIC of claim 2, wherein an AC impedance of the SHIC is above 1000 Ohms.

4. The SHIC of claim 2, wherein the magnetic paste comprises flakes of differing sizes.

5. The SHIC of claim 2, wherein the flakes comprise at least of nickel, iron, and cobalt.

6. The SHIC of claim 1, wherein the magnetic film comprises at least one of nickel, iron, cobalt, zirconia, and tantalum.

7. The SHIC of claim 1, wherein the magnetic film is also formed on a sidewall of the one or more vias.

8. A scalable high-impedance component (SHIC), comprising:
a flexible core;
a magnetic film formed on one or more sides of the flexible core;
a polymer layer formed on the magnetic film;
a metal layer formed on the polymer layer; and
a magnetic paste comprising metallic flakes, disposed on one or more sides of the SHIC.

9. The SHIC of claim 8, wherein the magnetic paste is applied to a thickness of about 100 micrometers.

10. The SHIC of claim 8, wherein the magnetic paste is selected to provide an alternating current impedance associated with a frequency range of about 200 MHz to about 1000 MHz.

11. The SHIC of claim 8, wherein the flexible core comprises polyimide.

12. The SHIC of claim 8, wherein the metallic flakes are between about 10 nanometers to about 10 micrometers.

13. The SHIC of claim 8, wherein the AC impedance is above 100 Ohms at 100-1000 MHz.

14. The SHIC of claim 8, wherein the AC impedance is above 100 Ohms and a total thickness of the SHIC is less than 0.2 mm.

15. A method of forming a SHIC, comprising:
forming a magnetic film on a carrier core;
forming a polymer layer on the magnetic film;
forming a metal layer on at least some of the polymer layer; and
applying a magnetic paste to at least one side of the SHIC.

16. The method of claim 15, wherein the metal layer comprises at least one of copper, silver, and nickel.

17. The method of claim 15, wherein the magnetic film is deposited via sputtering.

18. The method of claim 15, wherein the magnetic film comprises a cobalt alloy and is deposited using physical vapor deposition.

19. The method of claim 15, wherein the vias comprise a diameter of about 25 micrometers.

20. The method of claim 15, wherein the magnetic paste is applied to the one or more sides of the SHIC to a thickness of about 100 micrometers.
